(19) United States
(12) Patent Application Publication
(10) Pub. No.: US 2018/0089647 A1
(43) Pub. Date: Mar. 29, 2018

(54) SYSTEM AND METHOD FOR ELECTRONICALLY PROVIDING ELECTRONIC TRANSACTION RECORDS

(71) Applicant: MasterCard International Incorporated, Purchase, NY (US)

(72) Inventor: Mohammed Sadiq, Dubai (AE)

(21) Appl. No.: 15/276,917

(22) Filed: Sep. 27, 2016

(51) Int. Cl. G06Q 20/10; H04L 29/08

(52) U.S. Cl. CPC G06Q 20/102; H04L 67/306

(57) ABSTRACT

Systems and methods are provided for facilitating automatic provisioning of electronic records to a user conducting transactions at transaction terminals and using a variety of different transaction accounts. In particular, the transaction terminal can automatically capture a unique universal identifier (global ID) associated with the user. Using the global ID, the transaction terminal or another remote transaction processing system can provide transaction information to an independent server device for automatic record provisioning. In some implementations, based on the global ID, the server can identify an electronic contact address for the user and automatically transmit an electronic record to the user or otherwise provide the user with on-demand access to the record. The system thereby provides an automated transaction experience that does not require the user to actively input a contact address into the transaction terminal in order for the record to be automatically provided to the user.

### TECHNICAL FIELD OF THE DISCLOSURE

This patent application relates generally to the field of electronic transactions and, in particular, electronic systems configured to automatically generate electronic transaction records.

### BACKGROUND OF THE DISCLOSURE

Financial transactions are often performed by users at computer terminals. For example, bank transactions performed at an automated teller machine (ATM). By way of further example, point-of-sale (POS) devices are often used to conduct financial transactions between a consumer and a merchant for payment of goods or services.

With the widespread use of wireless communications and sophisticated mobile devices such as smart phones, tablet computers and the like, merchants are also using Mobile Point of Sale (MPOS) technology to conduct financial transactions. MPOS technology allows mobile devices to be used as a point-of-sale terminal. This is typically achieved by adding a hardware device (e.g., a dongle/card-reader, contactless transaction device reader, etc.) to accept electronic transaction information, thereby transforming a mobile phone into a POS device.

Many consumers use transaction cards, such as debit cards, credit cards or prepaid cards having magnetic strips or computer chips to complete such financial transactions. Another method for completing these transactions is “contactless” transaction, such as can be done using with PAYPASS® by Mastercard International Incorporated of Purchase N.Y., the assignee of the present disclosure. Using contactless transaction technology, consumers complete a payment transaction by bringing a contactless-enabled transaction device, such as a key fob, within proximity of a point-of-sale terminal reader, rather than swiping or inserting a card. With the rising popularity of near field communications (NFC) equipped smartphones, consumers are also completing contactless transactions using their smart phones instead of the traditional wireless transaction key fobs.

As would be understood, many financial transactions are memorialized in a record for the parties to the transaction. Traditionally, this is in the form of a paper receipt printed at a transaction terminal using a connected printer. In general, MPOS devices do not, by themselves, provide paper receipts. Although paper receipts can be provided by an attached printer, receipts are usually provided electronically to the consumer, for example, by short messaging service (SMS) to the consumer's telephone number or via e-mail. In some implementations, fixed transaction terminals can also be configured to transmit receipts electronically to consumers.

One drawback to transactions in which electronic receipts are transmitted to the consumer is that the consumer is required to enter their electronic contact addresses (e.g., e-mail, telephone number, etc.) into the POS/MPOS terminal. This is a lengthy and cumbersome process requiring active input that ultimately can hinder the user experience and use of these technologies. For example, when faced with a lengthy multi-step process to enter a contact address the consumer may prefer to pay with cash or not receive a receipt. In addition, the entry process is error prone, for example, typographical errors, and therefore the electronic receipts are often not transmitted to the appropriate electronic contact address.

Another barrier to performing transactions using POS devices is that the consumer often lacks trust in the electronic devices being used and/or the merchant using the POS device. For example, a consumer may be hesitant to share personal contact information using a POS device because the merchant's device or transaction processing system can be prone to hacking. In addition some customers may not be comfortable providing personal information to merchants for privacy reasons, say, for fear of unwanted contact from the merchant or sharing of personal contact information.

Similar drawbacks exist in systems for conducting other types of transactions that are commonly conducted between a user and a third-party and that are processed using, at least in part, electronic means. Transactions should be understood to include any type of agreement or arrangement established between a user and another party and that are commonly memorialized in a record, for example and without limitation, arrangements relating to goods, services and the like (e.g., ticketing for travel, reservations for lodging and entertainment, membership rewards, subscriptions for goods or services, promotional offers and the like). Moreover, existing systems for maintaining electronic records of a user's transactions are unable to effectively compile records across different service providers that are generally configured to operate independently and are not integrated.

As such, what is desired is a system that automatically identifies a user conducting a transaction so as to automatically provide the user with or access-to an electronic record and maintain electronic records relating to the transactions. It is also preferable that the system does so without requiring sensitive user information such as a personal electronic contact address for the user. It is also desirable to provide a system that can automatically identify and provide access to such records and related value adding services to users who have multiple transaction cards, user accounts and the like and for different types of transactions conducted across a variety of different and independent service providers. Furthermore, it is desirable to capture the necessary user information and other preferences for facilitating automatic record provisioning in a manner that enhances user privacy.

It is with respect to these and other considerations that the disclosure made herein is presented.

### SUMMARY OF THE DISCLOSURE

Technologies are presented herein in support of a system and method for facilitating an automatic provisioning of electronic records to a user completing transactions using a computing terminal.

According to a first aspect, the method for facilitating the automatic provisioning of an electronic record to a user completing a financial transaction at a transaction terminal using a transaction account associated with a first payment network among a plurality of payment networks is provided. The method includes providing a record provisioning application by a server to a transaction processor that is coupled to a transaction terminal and processes the financial transaction using the transaction account associated with the first payment network. The method also includes receiving a record provisioning request at the server over a communication network from the transaction processor in connection with processing of the financial transaction. The record provisioning request includes transaction information, transaction account information and non-transaction account information including a global ID. The method also includes identifying a user profile associated with the global ID among a plurality of user profiles stored in a non-transitory storage medium wherein the user profile includes one or more electronic contact addresses and one or more contact preferences. The method also includes confirming, by the server to the transaction processor based on the identification of the user profile, that the record provisioning request is processable. The method also includes generating, by the server based on the one or more contact preferences and the transaction information and the transaction account information, an electronic record concerning the financial transaction. The method further includes transmitting the electronic record by the server over the communication network to the electronic contact address. According to the method, the generating and transmitting steps are performed by the server free of contact with the transaction terminal and irrespective of the particular payment network associated with the transaction account.

According to another aspect, a method for facilitating an automatic provisioning of an electronic record to a user completing a financial transaction at a transaction terminal using a transaction account associated with a first payment network among a plurality of payment networks is provided. The method includes the step of receiving a record provisioning application, at a transaction processor from a server, wherein the transaction processor is coupled to the transaction terminal. The method also includes the step of receiving, at the transaction processor from the transaction terminal, transaction information, transaction account information and non-transaction account information including a global ID. The method also includes the step of processing the financial transaction using the transaction information, and transaction account information by the transaction processor. The method also includes the step of executing, in a processor of the transaction processing device, the record provisioning application. The record provisioning application configures the transaction processor to perform the step of transmitting, by the transaction processor to the server over a communication network a record provisioning request including the transaction information, the transaction account information and the non-transaction account information including the global ID. In accordance with the method, the record provisioning request is transmitted irrespective of the particular payment network associated with the transaction account. The method also includes the step of awaiting, by the transaction processor, record of a confirmation from the server that the record provisioning request is processable by the server. The method also includes the step of concluding the processing of the financial transaction by the transaction processor based on record of the confirmation from the server. In addition the method includes the step of transmitting, by the transaction processor to the server, a notification of the conclusion of the processing of the financial transaction.

These and other aspects, features, and advantages can be appreciated from the accompanying description of certain embodiments of the invention and the accompanying drawing figures and claims.

### BRIEF DESCRIPTION OF THE DRAWINGS

FIG. 1 is a high-level diagram illustrating computer system for facilitating the automatic provisioning of an electronic record to a user conducting a transaction at a computing device in accordance with certain embodiments of the invention;

FIG. 2 is a block diagram illustrating an exemplary configuration of a computing device for facilitating the automatic provisioning of an electronic record to a user conducting a transaction at a computing device in accordance with at least one embodiment disclosed herein;

FIG. 3 is a flow diagram showing a method for facilitating the automatic provisioning of an electronic record to a user conducting a transaction at a computing device in accordance with at least one embodiment disclosed herein;

FIG. 4 is a flow diagram showing a method for facilitating the automatic provisioning of an electronic record to a user conducting a transaction at a computing device in accordance with at least one embodiment disclosed herein; and

FIG. 5A is a block diagram showing configuration of the system for facilitating the automatic provisioning of an electronic record to a user conducting a transaction at a computing device and showing the transfer of information between devices in accordance with the embodiment depicted in FIG. 5A;

FIG. 5B is a block diagram showing an alternative configuration of the system for facilitating the automatic provisioning of an electronic record to a user conducting a transaction at a computing device and showing the transfer of information between devices in accordance with at least one embodiment disclosed herein;

FIG. 5C is a block diagram showing an alternative configuration of the system for facilitating the automatic provisioning of an electronic record to a user conducting a transaction at a computing device and showing the transfer of information between devices in accordance with at least one embodiment disclosed herein;

FIG. 6A depicts a screenshot of an exemplary user interface in accordance with at least one embodiment disclosed herein;

FIG. 6B depicts a screenshot of an exemplary user interface in accordance with at least one embodiment disclosed herein;

FIG. 6C depicts a screenshot of an exemplary user interface in accordance with at least one embodiment disclosed herein; and

FIG. 7 is a high-level diagram illustrating computer system for facilitating the automatic provisioning of an electronic record to a user conducting a transaction at a computing device in accordance with certain embodiments of the invention.

### DETAILED DESCRIPTION OF CERTAIN EMBODIMENTS OF THE DISCLOSURE

By way of overview and introduction, various systems and methods are described herein that facilitate the automatic provisioning of an electronic record to a user conducting a transaction at a computing device. The systems and methods described herein enable a series of operations whereby the user can conduct a transaction at a computing device (referred to herein as the “transaction terminal”) and the system is configured to automatically provision an electronic record of the transaction. For example, in one exemplary implementation, the transaction can be a financial transaction such as, the purchase of goods from a merchant at a point-of-sale device (POS) device or a mobile-point-of-sale (MPOS) device, or a banking transaction conducted at an automated teller machine (ATM). Preferably the user completes the transaction using a personal transaction device, such as, a transaction or payment card, or an electronic device enabled to conduct contactless transactions. In furtherance of the transaction, the transaction terminal can read transaction account information (e.g., bank account information, payment card information, rewards account information and the like) from the user's personal transaction device and process the transaction accordingly. In addition, as further described herein, the system is configured to automatically provision an electronic record of the transaction.

According to an aspect of the disclosed embodiments, the transaction terminal can also automatically capture a unique identifier of the user (referred to herein and in the figures as “global ID” or “One-ID”). Preferably, the global ID is assigned to the user independent of the underlying transaction account used by the user to conduct the transaction (e.g., a payment account associated with a credit provider or bank, or a rewards program account associated with a rewards card and the like). The global ID can be stored in the memory of the personal transaction device being used in connection with a transaction, another personal transaction device or can otherwise be known to the user and provided to the transaction terminal. The global ID and the associated record provisioning user-account can be maintained by a server that can be integrated with or associated with one or more transaction accounts. Transaction accounts can include, for example and without limitation, a credit or debit card account, an electronic transaction account, a user rewards account and the like. The user identifier can also be stored by the server in association with one or more stored electronic contact addresses for the user, for instance, an e-mail address, cellular telephone number, and the like.

The transaction terminal can be further configured to transmit the transaction account information and the global ID to one or more remote transaction processing systems. Accordingly, the remote computing devices can process the transaction. According to a salient aspect, one or more of the remote computing systems that traditionally process transactions in a manner that would be understood by those in the art can be communicatively coupled to the record provisioning server and can relay information including the transaction details and, preferably, the global ID. Using the global ID, the server can identify the particular user, identify the user's stored user profile and associated electronic contact addresses and can automatically provision an electronic record of the transaction.

Automatic provisioning, as further described herein, can include the compiling records of one or more transactions such that the records are accessible to a user on-demand, for instance, through an internet or application based portal. Provisioning should also be understood to include transmitting an electronic record to the user's contact address. In addition, the server can provide other push notifications relating to the user's transaction activity across a variety of different transaction accounts. Moreover, as noted above, the server can maintain a record of all of the user's transactions using the various transaction accounts and is also configured to provide a user portal through which the user can log-in and view the comprehensive records. In addition, the server can be further integrated with value added service (VAS) providers thereby enabling VAS providers to access the user payment records and provide VAS offers, promotions and benefits to users based on a wide array of transaction activity thereby providing additional value to the user.

The system thereby provides a uniquely automated transaction experience for the user in which a record is seamlessly provided electronically to the user without, a) requiring a user to actively input an electronic contact address into the transaction terminal, or b) requiring the electronic contact address to be stored in the memory of the personal transaction device and retrieved by the transaction terminal. In addition, the system thereby provides a more private transaction as personal contact information like an email address is not available to the operator or owner of the transaction terminal being used to conduct the transaction. The system also requires little modification or adjustment to legacy transaction processing infrastructure and processes.

It can be appreciated that any compiling of a user's transaction information or providing automatic access to a user's transaction information, contact information, transaction account information and the like would be subject to applicable data privacy and data usages laws. It should also be understood that the user can also require authorization before the server retrieves such information or provides it to third-parties such as VAS providers, issuers, acquirers, merchants and the like. Thus, it should be apparent that in the exemplary system and method described herein, depending on applicable laws and regulations, a consumer can opt-in, thereby consenting to the use of their transaction history as well as any other personal information he or she provides.

The systems and methods for facilitating the automatic provisioning of an electronic record to a user conducting a transaction at a transaction terminal are now described more fully with reference to the accompanying drawings, in which one or more illustrated embodiments and/or arrangements of the systems and methods are shown. The systems and methods are not limited in any way to the illustrated embodiments and/or arrangements as the illustrated embodiments and/or arrangements described below are merely exemplary of the systems and methods, which can be embodied in various forms, as appreciated by one skilled in the art. Therefore, it is to be understood that any structural and functional details disclosed herein are not to be interpreted as limiting the systems and methods, but rather, are provided as a representative embodiment and/or arrangement for teaching one skilled in the art one or more ways to implement the systems and methods. Accordingly, aspects of the present systems and methods can take the form of an entirely hardware embodiment, an entirely software embodiment (including firmware, resident software, micro-code, etc.), or an embodiment combining software and hardware. One of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer. Furthermore, the terms and phrases used herein are not intended to be limiting, but rather are to provide an understandable description of the systems and methods.

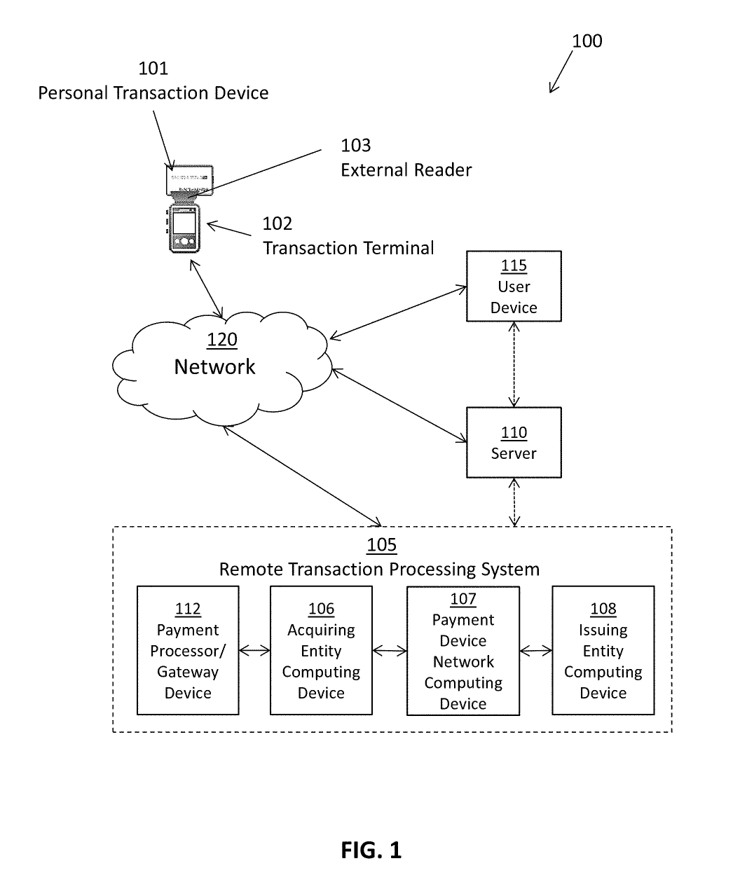

FIG. 1 is high-level diagram depicting an exemplary configuration of a system for facilitating the automatic provisioning of an electronic record to a user who is conducting a transaction at a transaction terminal 100. To the extent that the exemplary system of FIG. 1 is described in the context of processing a financial transaction conducted by a user using the transaction terminal 102, it should be noted that the system is not so limited. A transaction should be understood to include any other type of transaction, agreement, arrangement and the like that is entered into by a user with another party and is conducted using, at least in part, a computing device (e.g., terminal) and that can be memorialized in a record. For example and without limitation, transactions can include arrangements relating to goods, services and the like such as ticketing for travel, reservations for lodging and entertainment, membership rewards, subscriptions for goods or services, promotional offers and the like.

As shown in FIG. 1, the system 100 can include a transaction terminal 102 and a personal transaction device 101 (e.g., credit card, bank card, pre-paid card, membership rewards card, NFC enabled device, and the like) that is associated with the user (not shown) and a respective transaction account. The transaction account can be maintained by one or more remote computing devices that are configured to facilitate the processing of the transactions that are conducted using the transaction account (i.e., remote transaction processing system 105).

As further described herein, the transaction terminal 102 is intended to represent a computing device and/or data processing apparatus that is capable of facilitating electronic transactions in coordination with a remote transaction processing system 105 including, but not limited to, a dedicated POS system, ATM terminal, a personal computer, laptop computer, tablet computer or smart phone device and the like. Preferably, the transaction terminal 102 can use an internal or external reader 103 that is configured to read or receive information from one or more of a variety of personal transaction devices 101 presented by the user. Preferably, the transaction terminal 102 also includes a user interface and display that, as would be understood in the art of electronic computing devices, serves to facilitate the output of information to the user and the capture of commands and information concerning the user, the third-party or the particular transaction being conducted at the transaction terminal 102.

User device 115 is intended to represent various personal computing devices and/or data processing apparatuses associated with the user including, but not limited to, personal computers, tablet computers and smart phone devices and the like. The user device 115 can also be executing a client application that configures the user device 115 to communicate/interface with the system 100, in particular, the server 110. Accordingly, the user device 115 can be configured to collect information from the user, communicate the information to the server 110 (or other such remote devices) and receive information from the server 110 for display to the user. More specifically, the client application is a software application comprising instructions in the form of code that, when executed by the user device processor (not shown), configures the computing device to receive and process information concerning the user, settings relating to the operation of the systems and methods for facilitating the automatic provisioning of an electronic record, for instance to receive electronic receipts provided by the server 110 and receive other information related to the transactions conducted by the user and recorded by the server 110. It can be appreciated that the client application can comprise a stand-alone software application executing on the user device 115 or can be executing on one or more remote server devices that are accessible by the user device over a network, for instance, a web-based portal that is accessed by the user device through a web browser or other such application.

In addition, the transaction terminal 102 can also be integrated with the system 100 by executing a respective instance of the client application. For instance, through integration of the server 110 with a payment processor/gateway device 112, all computing devices configured to process transactions via the payment processor/gateway device 112 can be configured to collect information concerning the user in furtherance of the methods for facilitating the automatic provisioning of an electronic record to a user as further described herein.

As shown in FIG. 1, the system 100 can also include a transaction processing system 105 comprising one or more computing devices. Such computing devices directly/indirectly transmit and/or receive data to/from the transaction terminal 102, thereby preferably initiating, facilitating, maintaining, and/or enhancing the operation of the systems for facilitating the automatic provisioning of an electronic record to a user completing a transaction at a transaction terminal 100, as will be described in greater detail below.

More specifically, the transaction processing system 105 can include one or more server computing devices (or computing networks) that are configured to receive information concerning the transactions conducted using the transaction terminal 102 and process the transactions as would be understood by those skilled in the art. For instance, in the case of a financial transaction processing system, the transaction processing system 105 can include an acquiring entity computing device 106 operated by an acquirer, which is typically the bank associated with the merchant. The transaction processing system 105 can also include a payment processor/gateway device 112, which typically processes transactions on behalf of the merchant and the merchant's acquirer. The transaction processing system 105 can also include a payment device network computing device 107 operated by a payment device network, for example, Mastercard International Incorporated of Purchase N.Y. The transaction processing system 105 can also include an issuing entity computing device 108 operated by an issuing financial institution, which is typically the bank associated with the user or transaction account holder, as would be understood by those in the art.

The various devices comprising the remote transaction processing system 105 directly/indirectly transmit and/or receive data to and from the transaction terminal 102 and the server 110, for example via a communications network 120, thereby preferably initiating, facilitating, maintaining, and/or enhancing the operation of the systems for facilitating the automatic provisioning of an electronic record to a user completing a transaction at a transaction terminal 102, as will be described in greater detail below. Communication network 120 can include, for example and without limitation, a wired or wireless network, including a telecommunications network, local area network (LAN) or a wide area network (WAN), the Internet and the like.

The server 110 is also shown in communication with one or more of the devices that comprise the remote transaction processing system 105 as well as user device 115 and, optionally, transaction terminal 102. Server 110 is depicted as being independent of the remote transaction processing system 105. Accordingly, the server 110 can be configured to be integrated with any number of different acquirers, issuers and payment device networks so as to automatically provide records and services to users for transactions conducted with transaction accounts associated with any number of payment processing entities. However, it can be appreciated that server 110 and its features and functionality can be integrated into one or more of the computing devices that comprise the processing system 105 without departing from the scope of the disclosed embodiments.

In some implementations, the transaction terminal 102 can be associated with an entity that the user is transacting with, such as a bank or a merchant. The transaction terminal 102 can be used to collect information related to the transaction from the user and/or the third-party, communicate the information to the transaction processing system 105 and, in addition or alternatively, the server 110, and receive information from these remote devices. The transaction terminal 102 can be operated by a representative of the entity (e.g., a clerk) who conducts the transaction with the user using the transaction terminal 102. Alternatively, the transaction terminal 102 can be a stand-alone device, such as a self-checkout terminal or an ATM machine, configured to conduct transactions directly with the user.

Personal transaction device 101 can include transaction cards associated with transaction accounts, for example, financial accounts such as debit cards, credit cards or prepaid cards. The transaction accounts can be associated with an account holder or the user who is not necessarily the account holder. As would be understood by those skilled in the art, a debit card is a transaction card issued for a demand deposit account. A credit card is a transaction card issued for a credit card account. A prepaid card is a transaction card issued for a pre-funded account.

In addition, or alternatively, personal transaction device 101 can be a “contactless” transaction device associated with one or more transaction accounts. For example, the contactless-enabled devices can include a transaction card, a key-fob, or smart-phone. As would be understood by those skilled in the art, contactless transaction devices generally employ NFC technology, which facilitates secure, short range communication between electronic devices. More specifically, NFC is a short range high frequency wireless communication technology that enables the exchange of data between devices over a relatively short distance.

The personal transaction device 101 (e.g., debit cards, credit cards, prepaid cards and NFC enabled devices) can have an embedded computer readable memory (not shown) for securely storing transaction account information therein. The transaction account information can include financial information, such as a credit or debit account number, the account holder's name, a card verification code, loyalty program data, PINs and the like. Personal transaction device memory can be any suitable volatile or non-volatile computer readable storage medium, including, for example and without limitation, magnetic strips, onboard computer chips and more complex electronic systems such as NFC transponders, RFID transponders and the like. In addition, the memory can be read-only or rewriteable.

As would be understood by those skilled in the art, personal transaction devices for conducting financial transactions and having a magnetic stripe can typically store information in three “tracks.” Tracks 1 and 2 are often used to store transaction account information that is used to process financial transactions. In some implementations, a unique global ID can be stored in a ‘discretionary data’ field of the commonly used tracks (track-1 and track-2). In addition, or alternately, the global ID can be stored in a discretionary data track, for example, track-3. By storing the global ID in a discretionary data track, the electronic contact information is not constrained by formatting standards set for tracks 1 and 2. Accordingly, information stored on the discretionary track can be used by any one or more of the transaction processing entities involved in the transactions, say, the issuer of the personal transaction device.

Personal transaction devices having onboard computer chips can use data elements to store information like a financial account number and additional parameters. Such chip devices can also have data elements that are “reserved for future use.” Accordingly, the unused data elements can be used to store the user's contact information. In addition, NFC enabled transaction devices can follow either magnetic stripe transaction device or chip transaction device formats.

It should be noted that although much of the foregoing description has been directed to systems for processing transactions between a user and a merchant conducted at a point of sale device, the particular arrangement of devices, particularly, the transaction terminal 102, the remote transaction processing system 105 and the server 110, as well as the transaction processing steps, are presented as a non-limiting and exemplary environment in which the systems and methods for facilitating the automatic provisioning of an electronic record to a user conducting a transaction at a transaction terminal described herein can be employed.

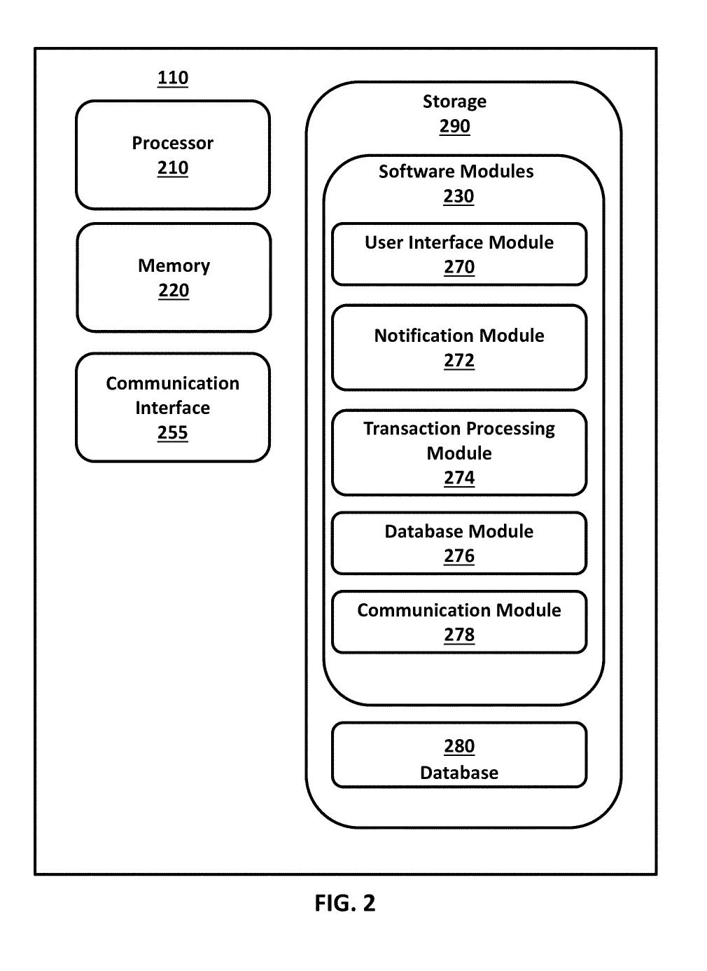

FIG. 2 is a high-level diagram illustrating an exemplary configuration of the server 110 for use in the system for facilitating the automatic provisioning of an electronic record to a user conducting a transaction at a transaction terminal 102.

Exemplary server 110 includes a processor 210, which is operatively connected to various hardware and software components that serve to enable operation of the systems and methods described herein. The processor 210 serves to execute instructions to perform various operations relating to transactions conducted by a user electronically and for facilitating the automatic provisioning of an electronic record as will be described in greater detail below. The processor 210 can be a number of processors, a multi-processor core, or some other type of processor, depending on the particular implementation.

In certain implementations, a memory 220 and/or a storage medium 290 are accessible by the processor 210, thereby enabling the processor 210 to receive and execute instructions stored on the memory 220 and/or on the storage 290. The memory 220 can be, for example, a random access memory (RAM) or any other suitable volatile or non-volatile computer readable storage medium. In addition, the memory 220 can be fixed or removable.

The storage 290 can take various forms, depending on the particular implementation. For example, the storage 290 can contain one or more components or devices such as a hard drive, a flash memory, a rewritable optical disk, a rewritable magnetic tape, or some combination of the above. The storage 290 also can be fixed or removable.

One or more software modules 230 are encoded in the storage 290 and/or in the memory 220. The software modules 230 can comprise one or more software programs or applications having computer program code or a set of instructions executed in the processor 210. Preferably, included among the software modules 230 is a user interface module 270, a notification module 272, a transaction processing module 274, a database module 276, and a communication module 278 that are executed by the processor 210. Such computer program code or instructions for carrying out operations or aspects of the systems and methods disclosed herein can be written in any combination of one or more programming languages, as would be understood by those skilled in the art. In particular, user interface module 270 serves to configure the processor 210 to provide a user portal through which a user using the user device 115 executing the client application can access the server 110 and information stored thereon. Notification module 272 serves to configure the processor 210 to generate receipts and other push notifications concerning the user's transaction activity to one or more electronic contact addresses associated with the user. Transaction processing module 274 serves to configure the processor 210 to receive transaction information concerning one or more user transactions, analyze and process the information as further described herein. Database module 276 serves to configure the processor to generate and maintain user profiles associated with each enrolled user and the enrolled user's unique global ID. The database module 276 further configures the processor 210 to update the user profiles with settings, preferences and transaction information. Communication module 278 serves to configure the processor 210 to communicate with various computing devices that comprise the system for facilitating the automatic provisioning of an electronic record 100.

It should be understood that, although software modules 230 are depicted as being stored locally by the server 110, the disclosed embodiments are not so limited, as one or more of the modules can be stored on one or more remote storage mediums that are accessible to the processor 210. The program code can execute entirely on the server 110 as a stand-alone software package, partly on the server 110 and partly on one or more remote computing devices, or entirely on such remote computing devices. In the latter scenario, the remote computing devices can be connected to the server 110 through any type of wired or wireless network (not shown), including a local area network (LAN) or a wide area network (WAN), or the connection can be made to an external computer (for example, through the Internet using an Internet Service Provider).

It should be understood that in some illustrative embodiments, one or more of the software modules 230 can be downloaded over a network to the storage 290 from another device or system via the communication interface 255 for use within the system 100 for facilitating the automatic provisioning of an electronic record to a user conducting a transaction at a transaction terminal. For instance, program code stored in a computer readable storage device in a remote server can be downloaded from the server to the storage 290 over the network.

Also preferably stored on the storage 290 is a database 280. As will be described in greater detail below, database 280 contains and/or maintains various data items and elements, such as user profiles, transaction records and the like that are utilized throughout the various operations of the system for facilitating the automatic provisioning of an electronic record to a user conducting a transaction at a transaction terminal 102. It should be noted that although the database 280 is depicted as being configured locally to the server 110, in certain implementations the database 280 and/or various of the data elements stored therein can be stored on a computer readable memory or storage medium that is located remotely and connected to the server 110 through a network, in a manner known to those of ordinary skill in the art.

A communication interface 255 is also operatively connected to the processor 210. The communication interface 255 can be any interface that enables communication between the transaction terminal 102 and external devices, machines and/or elements. In certain implementations, the communication interface 255 includes, but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, and/or any other such interfaces for connecting the server 110 to other computing devices and/or communication networks, such as private networks and the Internet. Such connections can include a wired connection or a wireless connection (e.g., using the IEEE 802.11 standard known in the relevant art) though it should be understood that communication interface 255 can be practically any interface that enables communication to/from the processor 210.

At various points during the operation of the systems and methods disclosed herein, the server 110 can communicate, directly or indirectly, with one or more of the computing devices that comprise the remote transaction processing system 105, transaction terminal 102 and/or the user device 115 depicted in FIG. 1.

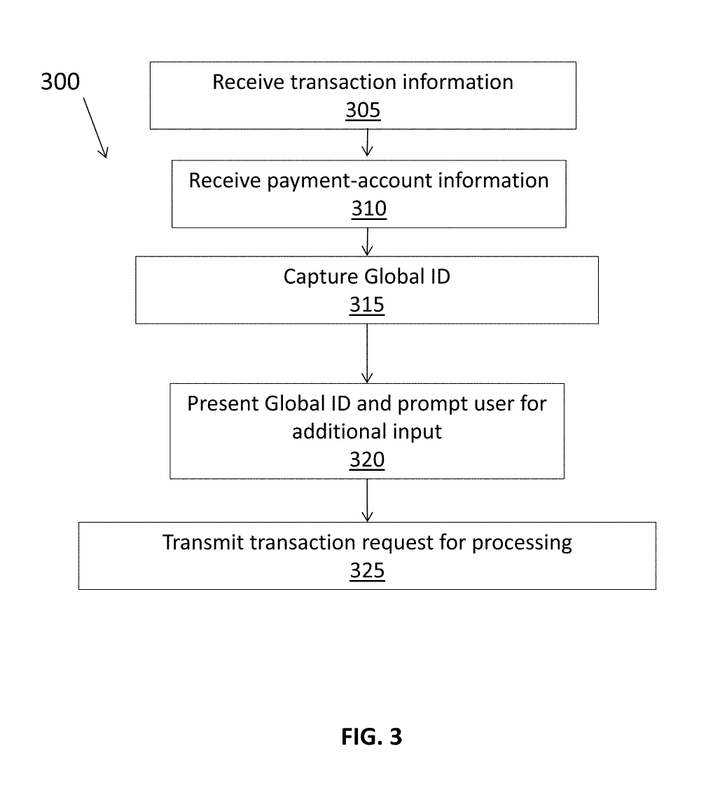

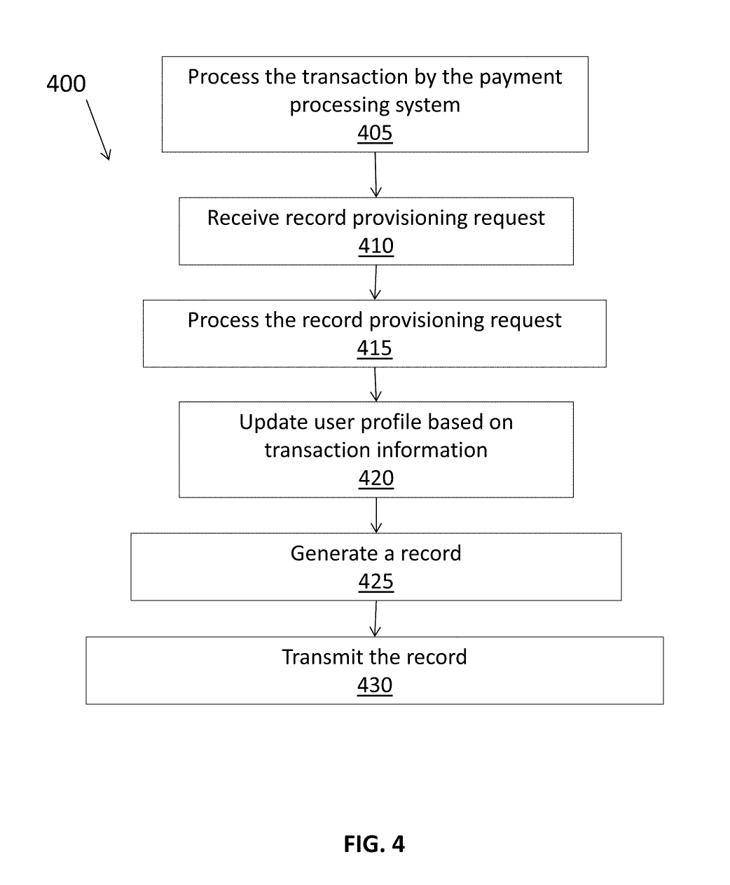

The operation of the exemplary system for facilitating the automatic provisioning of an electronic record to a user conducting a transaction at a transaction terminal and the various elements and components described above will be further appreciated with reference to the method for facilitating the automatic provisioning of an electronic record to a user conducting a transaction at a transaction terminal described below, in conjunction with FIG. 3 and FIG. 4.

It should be appreciated that several of the logical operations described herein are implemented (1) as a sequence of computer implemented acts or program modules running on the various devices of the system for facilitating the automatic provisioning of an electronic record to a user conducting a transaction at a transaction terminal 102 and/or (2) as interconnected machine logic circuits or circuit modules within the system. The actual implementation is a matter of design choice dependent on the requirements of the device (e.g., size, energy, consumption, performance, etc.). Accordingly, the logical operations described herein are referred to variously as operations, steps, structural devices, acts, or modules. As referenced above, the various operations, steps, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

Preferably, at some point prior to using the system for facilitating the automatic provisioning of an electronic record 100, one or more users are enrolled with the system. Enrollment can be performed by the server 110 in conjunction with one or more computing devices being operated by the user including, for example and without limitation, the user device 115 or the transaction terminal 102, which are configured by executing the client application.

During enrollment, the server processor 210, which is configured by executing one or more software modules 230 including, preferably, the user interface module 270, database module 276, and communication module 278, can be configured to prompt the user at a remote computing device being used by the user (e.g., transaction terminal 102 or user device 115) to input user-information. The user information can be received and stored by the server 110 in the database 280 for example, in a user profile.

The user information can include information about the user's identity (e.g., name, address, social security number, biometric information etc.), one or more electronic contact addresses and transaction account information for the user. The electronic contact addresses can include any type of electronic address that is uniquely associated with the user. By way of example and without limitation, an electronic contact address can include, a telephone number, an e-mail address, social network identifier (e.g., Facebook® account name, Twitter® handle, etc.), a networked electronic storage medium address (e.g., iCloud® account name, Dropbox® account name, etc.), and/or a unique account name or number associated with other networked software applications, for example, a user's personal accounting software.

The user transaction accounts, electronic addresses and identity information that comprise a particular user's profile can be linked in the storage with a unique common name for the user, namely, the user's global ID. The global ID can be automatically assigned by the server during enrollment or chosen by the user. It can be appreciated that any number of transaction accounts held by the user, irrespective of the particular account provider (e.g., an issuer or payment device network), can be mapped to the common, unique global ID and, as such, electronic records can be automatically provided for the user irrespective of the transaction account used for conducting a particular transaction. After enrollment, the global ID can be provided to the user such that the user can memorize the global ID. Accordingly, in some implementations the user can provide the global ID to the transaction terminal, for instance, through manual entry into the terminal or verbally providing the global ID to the terminal. In addition, or alternatively, the global ID can be loaded into memory of the user's personal transaction device 101 or other personal transaction device such that the global ID can be automatically retrieved by the transaction terminal 102 from the personal transaction device 101.

User enrollment can also include prompting the user to define contact preferences. Contact preferences define the particular manner in which the user desires to receive electronic records of transactions. Contact preferences can also include other settings that relate to the capture and storage of information relating to the user's transactions and reporting of the stored information to the user and/or third-parties by the server 110. For example, the pre-defined contact preferences can specify that one or more of the stored electronic contact addresses are default contact address that the system should automatically transmit the record to. In addition, or alternatively, the contact preferences can specify one or more priority levels associated with the one or more electronic contact addresses such that the electronic record can be transmitted to the contact addresses according to the associated priority levels. In some implementations, the contact preferences can specify instructions to not automatically transmit the record to any of the one or more electronic contact addresses. By way of further example, contact preferences can specify that the user's transaction information is not to be shared with a particular VAS provider system and the issuers of the user's respective transaction accounts and that the stored transaction information is otherwise not sharable with any other third-parties.

During enrollment, the server 110 can also be configured to perform user identity verification, transaction account verification and messaging account verification for security. Identity verification provides additional security by confirming that the user being enrolled is who he or she claims to be. Messaging account verification ensures that the user has access to the messaging accounts associated with the user profile. Transaction account verification serves to confirm that a user is in fact the account holder for the transaction accounts being registered or is otherwise an authorized user of the transaction accounts. For instance, the server processor 210 can be configured to transmit a message to the received contact address thereby prompting the user to confirm receipt of the message and, as such, ensures that the user has access to the particular messaging account. By way of further example, the server 110 can verify the transaction account information by testing the user identity information and transaction account information against information that is stored on a secure data store that is accessible to the server 110 (e.g., testing the user transaction account, identity information or an online banking log-in/password against the records maintained by the issuing bank).

Turning now to FIG. 3, a flow diagram illustrates a method 300 for facilitating the automatic provisioning of an electronic record to a user conducting a transaction at a transaction terminal in accordance with at least one embodiment disclosed herein.

The process begins at step 305, where the transaction terminal 102 receives transaction information concerning a transaction conducted by the user at the transaction terminal 102. In the context of a financial transaction for the purchase of goods by the user from a merchant, the transaction information can include a description of the goods being purchased, a price, information identifying the third-party, tax, and the like, as would be understood by those skilled in the art. For example, the merchant or the user can enter the transaction information manually using the user interface of transaction terminal 102 or by scanning a product barcode, QR code and the like.

Then, at step 310, the transaction terminal using the electronic reader 103, receives transaction account information from a personal transaction device 101 presented to the transaction terminal 102 by the user. As mentioned above, the transaction account information can include financial information associated with the user or a payment account holder such as, a credit or debit account number, the account holder's name, a card verification code, personal identification numbers, or other forms of user identifying information or financial account related information.

More particularly, the processor of the transaction terminal 102 and the electronic reader 103 can read one or more fields of the transaction device's memory that are reserved for transaction account information and store the captured information. For example, in order to transfer the information, the user can ‘tap’ an NFC-enabled personal transaction device 101 against an NFC-enabled electronic reader 103. By way of further example, the user can swipe a magnetic stripe enabled personal transaction device 101 on an electronic reader that is configured to read magnetic stripe cards.

Then, at step 315, the transaction terminal 102 captures a global ID. In some implementations, the electronic reader 103 can read one or more of the memory fields of the personal transaction device 101 that are reserved for storing non-transaction account information and capture the information stored therein. In addition, or alternatively, the electronic reader can read one or more ‘discretionary data’ fields of the personal transaction device memory and capture information including the global ID stored therein in a similar fashion to how the transaction account information is captured at step 310. In addition, or alternatively, the user can be prompted to provide the global ID using a user interface of the transaction terminal 102. For example, if the information captured does not include a global ID, as determined by the transaction terminal 102 or an associated payment processor/gateway device 112, the user can be prompted by the transaction terminal 102 to input a global ID using a keyboard. Alternatively, the global ID can be verbally provided to the terminal and automatically captured.

In some implementations, the global ID can be captured from a different personal transaction device than the particular personal transaction device 101 being used to conduct the transaction. For instance, even though a transaction is conducted using transaction device 101, the transaction terminal can capture the global ID from a different personal transaction device that is presented to the transaction terminal, say, an NFC enabled device (e.g., user device 115) configured to output the global ID as an encoded wireless signal. By way of further example, the personal transaction device can be configured to output the global ID in an optical format using a display (e.g., as a QR code or barcode) such that it can be read by the transaction terminal 102.

Then at step 320, the transaction terminal 102 can present the captured global ID and associated information to the user via an associated display. In addition, or alternatively, the transaction terminal 102 can prompt the user for additional user input. For instance, the transaction terminal 102 can display one or more forms or virtual buttons on a touchscreen display prompting the user to input information relating to the global ID, contact addresses, transaction accounts or enrollment information.

At step 325, the processor 210, transmits a transaction request including at least a portion of the transaction information, the transaction account information, the global ID and/or other captured user information and user inputs to the remote transaction processing system 105.

The steps for processing the transaction request, including generating the electronic record for the transaction and electronically provisioning the record to the user are described in further detail in relation to the flow diagram of FIG. 4, which illustrates an exemplary method 400 for facilitating the automatic provisioning of an electronic receipt to a user conducting a financial transaction at a transaction terminal in accordance with at least one embodiment disclosed herein.

At step 405, the payment processor/gateway device 112 can, based on the transaction request including the transaction information and the transaction account information, process the financial transaction. By way of example and without limitation, as would be understood by those skilled in the art, at least the transaction information and transaction account information can be transmitted to an acquiring entity computing device 106. The acquiring entity computing device 106 can, in turn, route the information to the issuing entity computing device 108 via the payment device network computing device 107, thereby prompting the issuing entity computing device 108 to authorize the transaction. The issuing entity computing device 108 can then transmit an authorization notification indicating whether the transaction was authorized to the acquiring entity computing device 106. In turn, the acquiring entity computing device 106 can also pass the authorization notification back to the payment processor/gateway device 112.

Then at step 410, the server 110 receives a record provisioning request from the payment processor/gateway device 112. More specifically, through integration with the server 110, the payment processor/gateway device 112 can be provided with a record provisioning application that configures the payment processor/gateway device 112 to analyze the transaction request and generate a record provisioning request for transmission to the server 110 for further processing. In some implementations, the payment processor/gateway device 112 can be configured to analyze the transaction request (e.g., the non-transaction account information received from the transaction terminal 102) to determine whether the transaction request includes a global ID. If a valid global ID is not identified, the payment processor/gateway device 112 can transmit a message to the transaction terminal 102 causing the transaction terminal to prompt the user to enter a global ID. Similarly, if a global ID is detected, the payment processor/gateway device 112 can prompt the transaction terminal to display the global ID to the user and request a confirmation of the global ID from the user. It can be appreciated that the global ID can be presented in plain form or in a masked or obfuscated manner.

Upon identification of a valid global ID the payment processor/gateway device 112 can be configured to transmit a record provisioning request that includes the global ID. The information include in the request can also include at least a portion of the transaction information, the transaction account information and the authorization notification. In addition, or alternatively, the record provisioning request can include at least a portion of the transaction information, the transaction account information and the authorization notification in a masked format. The record provisioning request can also include additional information concerning the transaction that was generated by one or more of the acquiring entity computing device 106, the payment device network computing device 107 and the issuing entity computing device 108 during payment processing and received by the payment processor/gateway device 112.

Then at step 415, the server 110 processes the record provisioning request. More specifically, the server processor 210, which is configured by executing one or more of the software modules 230 including, preferably, the notification module 272, the transaction processing module 274 and the database module 276 can process the record provisioning request to identify the user profile in the database 280 that corresponds to the global ID.

In addition, the configured processor can identify one or more contact addresses associated with the user profile. The one or more contact addresses can be identified according to one or more contact preferences included in the particular user profile. As previously noted the user profile can include any number of pre-defined contact preferences and settings that serve to instruct the manner in which the server 110 generates a record, transmits the record, processes and records the transaction, and reports the transaction. Accordingly, the preferences can be associated with one or more of the particular transaction account used to conduct the transaction, one of the user's registered contact addresses, the particular merchant that the transaction was conducted with and other attributes of the transaction.

If the server 110 does not identify a user profile based on the information provided in the record provisioning request, the server can be configured to provide a notification to the payment processor/gateway device 112. Accordingly, the payment processor/gateway device 112 can transmit a message to the transaction terminal 102 causing the transaction terminal to prompt the user to re-enter the global ID. Similarly, the server 110 can be configured to transmit a confirmation to the payment processor/gateway device 112. Accordingly, the payment processor/gateway device 112 can be configured to not conclude the processing of the financial transaction until the confirmation is received. It can also be appreciated that the payment processor/gateway device 112 can be configured to provide notifications to the transaction terminal concerning the processing of the transaction terminal and the confirmation that the record provisioning request is processable by the server.

In addition, at step 420, the configured processor can update information concerning the transaction to the user profile. Accordingly, the server 110 can be configured to maintain a comprehensive transactional record for the user concerning all electronic transactions performed by the user using the global ID irrespective of the particular transaction account used to conduct the transaction.

Then at step 425, the server generates a record according to the transaction information, the transaction account information and the authorization notification included in the record provisioning request. More specifically, the server processor 210, which is configured by executing one or more of the software modules 230 including, preferably, the notification module 272 and the transaction processing module 274 and the database module 276 can generate a record for transmission to the one or more contact addresses in view of the contact preferences identified at step 420. For example, the record can include details about the particular purchase, the particular transaction account used and whether the transaction was approved and other information relevant to the transaction, as would be understood by those skilled in the art.

Then, at step 430, the server 110 can transmit the generated record to one or more electronic contact addresses associated with the global ID. In addition, the record can be transmitted according to one or more pre-defined contact preferences stored in the user profile and/or any user instructions received by the transaction terminal 102 and included in the transaction request. For example, the record can be automatically transmitted to a default electronic contact address as set forth in the user profile. By way of further example, the record can be transmitted to a particular electronic contact address associated with the particular transaction account used to conduct the transaction as provided by the pre-defined contact preferences. By way of further example, the server 110 can first transmit the electronic record to an electronic contact address having a highest priority level, and in the event that the record is not successfully transmitted, the server 110 can transmit the electronic record to the electronic contact address with the next highest priority and so on. By way of further example, the server can e-mail a detailed receipt to the user's e-mail address and can also transmit a basic notification via SMS to the user's mobile phone number. It should be understood that these are non-limiting examples and it should be understood that the electronic record can be transmitted according to any number of different pre-defined contact preferences or settings stored in the user profile and/or user instructions provided while conducting the transaction.

In addition, or alternatively, at step 430, the server 110 can be configured to provide the generated record (e.g., a receipt memorializing a financial transaction) to the user only upon the user submitting a request for the information. More specifically, the server processor 210, which is configured by executing one or more of the software modules 230 including, preferably, the user interface module 210, the notification module 272, the transaction processing module 274, the communication module 278 and the database module 276, can provide a portal that is accessible to the user using the user device 115 that is executing the client application.

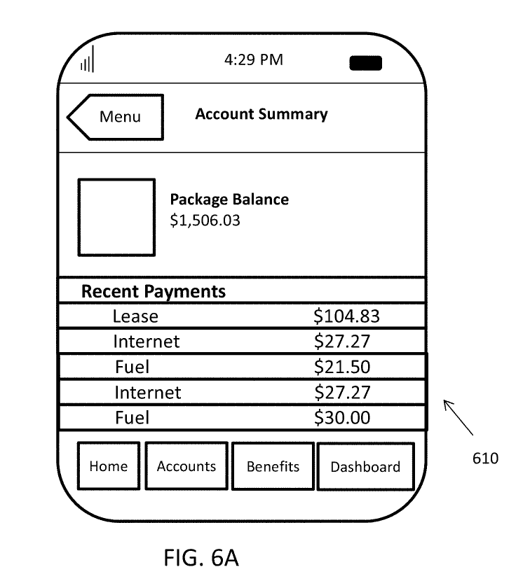

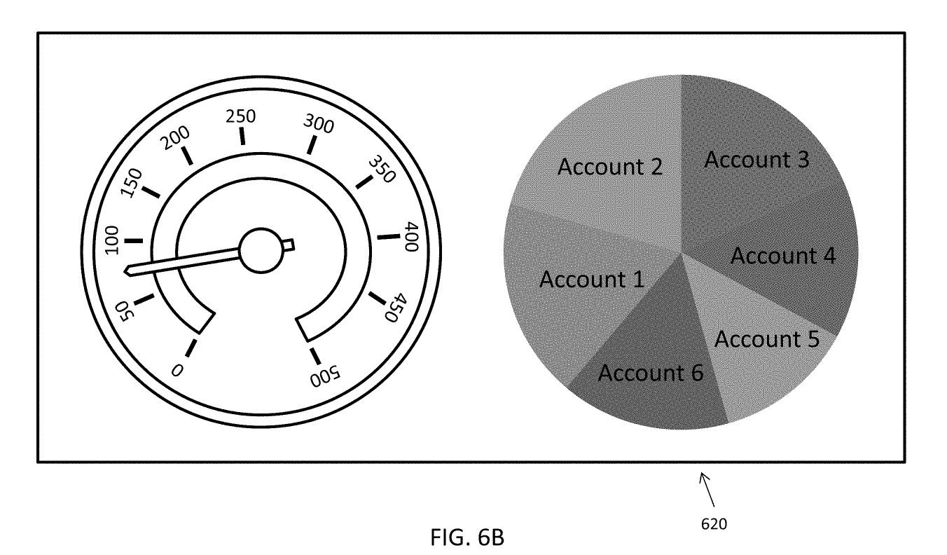

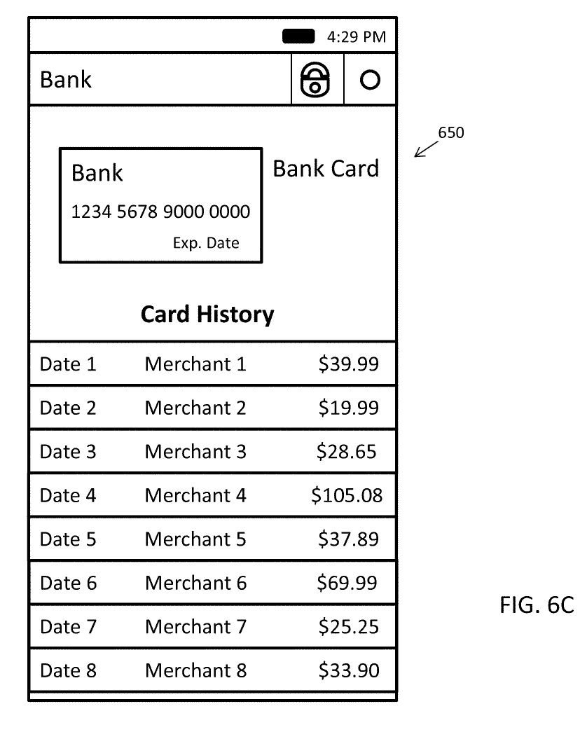

For example, using the user device 115 executing the client application, the user can log-into the server 110 and access an interactive dashboard concerning the user's various transactions. As would be appreciated by those in the art, the dashboard can provide the user with information concerning each of the user's transactions and can also provide access to records generated for one or more of the transaction. In addition, the dashboard can provide a historical view of all transactions conducted by the user under the global ID and irrespective of the particular transaction account. Similarly, the dashboard can be configured to provide the user with additional expense monitoring features and services. An exemplary screen-shot 610 of the dashboard displaying a history of all transactions irrespective of transaction account in table form is shown in FIG. 6A. FIG. 6B depicts another exemplary screenshot 620 of the dashboard showing a graphical break-down of the user's expenses by category for, say, expense monitoring purposes. FIG. 6C depicts another exemplary screenshot 650 of a transaction history for one particular transaction account among the plurality of transaction accounts associated with the user's global ID.

It can be appreciated that any compiling of a user's transaction information or automatic access to a user's transaction information, contact information, transaction account information and the like would be subject to applicable data privacy and data usages laws. It should also be understood that the user can also require authorization before the server 110 retrieves such information or provides it to third-parties. Thus, it should be apparent that in the exemplary systems and methods described herein, depending on applicable laws and regulations, a consumer can opt-in, thereby consenting to the use of their transaction history as well as any other personal information he or she provides.

In addition, through the dashboard, the user can define settings that concern the operation of the for facilitating the automatic provisioning of an electronic record 100 by the server 110 including the sharing of private user transaction information with third-party entities that consume the transaction information compiled by the server.

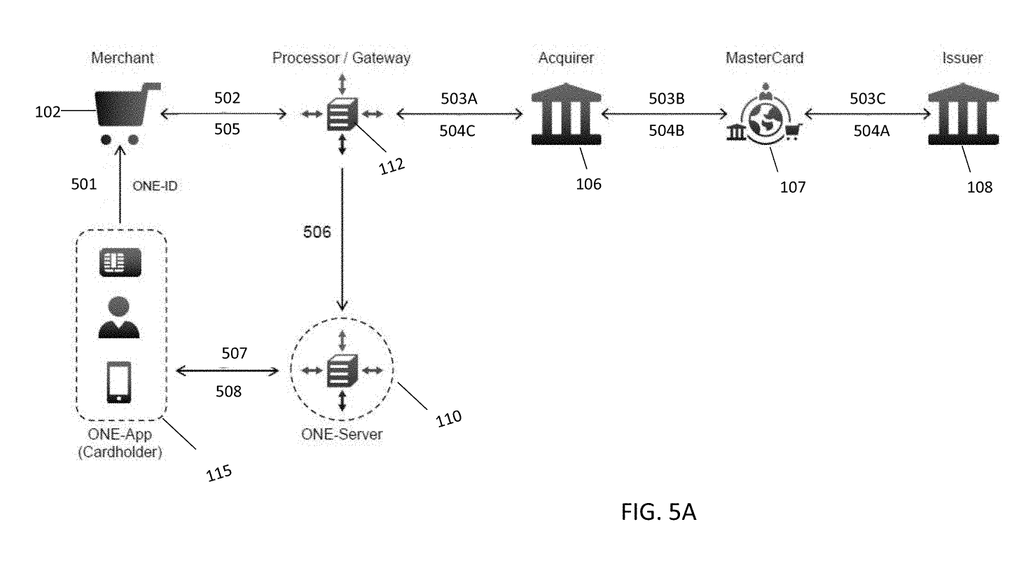

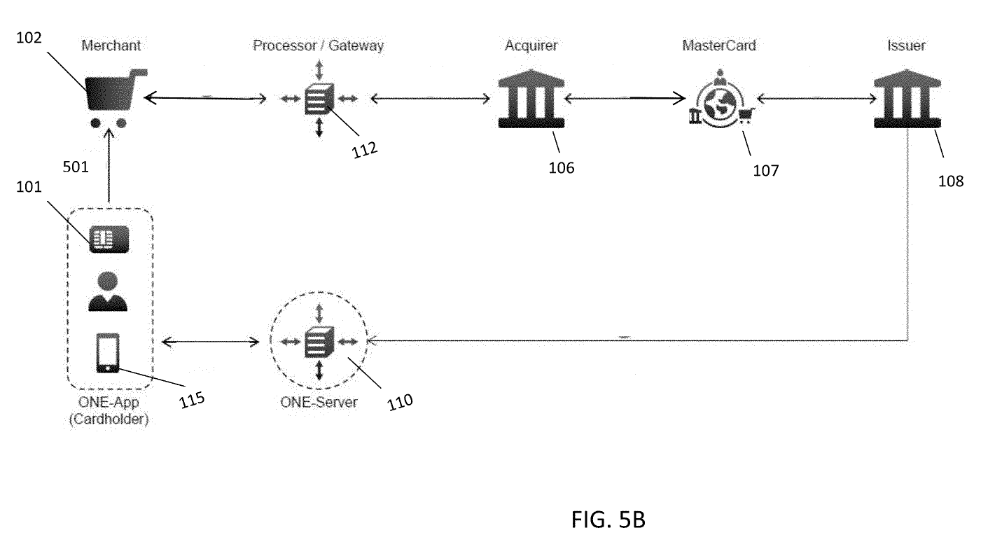

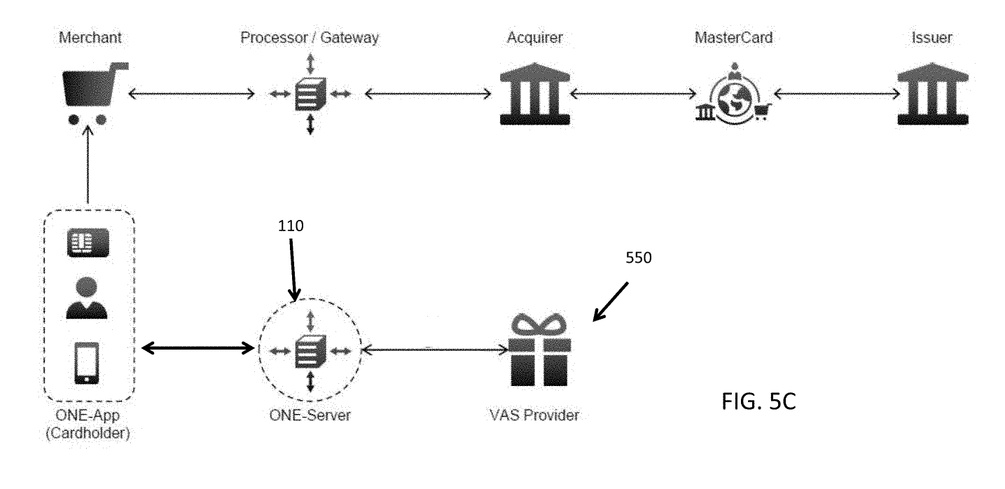

FIG. 5A is a block diagram depicting the various components of the system for facilitating the automatic provisioning of an electronic record to a user conducting a financial transaction at a transaction terminal 102 and showing the transmission of information between the various devices during the execution of the exemplary methods described in relation to FIGS. 3 and 4. In particular, step 501 corresponds to the exchange of user transaction account information and non-transaction account information between the personal transaction device 101 and the transaction terminal 102 associated with the merchant. Step 502 depicts the transmission of the transaction request to the payment processor/gateway device 112. Steps 503A-C corresponds to the transmission of information between the payment processor/gateway device 112, the acquiring entity computing device 106, the payment device network computing device 107 and the issuing entity computing device 108 while processing the transaction. Steps 504A-C corresponds to the transmission of the authorization notification from the issuing entity computing device 108 back to the payment processor/gateway device 112 via the acquiring entity computing device 106 and payment device network computing device 107. Step 506 corresponds to the transmission of the record provisioning request from the payment processor/gateway device 112 to the server 110. Steps 507 and 508 correspond to the exchange of information relating to the transactions between the server 110 and the user device 115, for instance, the transmission of the record directly to a user contact address and/or the transmission of other push notifications concerning promotional offers, benefits, security warnings and the like. By way of further example steps 507 and 508 can represent the information exchanged via the user-interface/portal that is hosted by the server 110 and is accessible to the user using a user device 115 executing the client application.

FIG. 5B depicts an alternative configuration of the system for facilitating the automatic provisioning of an electronic record 100 and the transmission of information between the various devices during the execution of the exemplary methods described in relation to FIGS. 3 and 4. In particular, as shown in FIG. 5B, the record provisioning request can be transmitted by the issuing entity computing device 108 (as opposed to being transmitted by the payment processor/gateway device 112 as shown in FIG. 5A and described in relation to step 410 of FIG. 4) to the server 110. In addition, FIG. 5B also depicts the transmission of information concerning one or more transactions from the server 110 back to the issuing entity computing device 108. As further described herein, information provided to the issuing entity computing device 108 can include transaction records and analytics based on that information for use by the issuing entity computing device 108.

As can be appreciated, by independently generating records and recording transaction information across a plurality of different transaction accounts associated with respective of the issuer entity, acquirer entity, payment device network associated with the transaction accounts used to conduct the transactions, the server 110 is configured to maintain a rich set of information relating to a wide variety of consumer transactions. As can be further appreciated, the systems and methods disclosed herein are configured to provide value to consumers by automatically providing electronic records to users and providing a convenient location for storing and accessing all electronic transaction information relating to the user irrespective of the particular transaction account and associated transaction processing entity. The exemplary systems and methods are also configured to provide additional value to users and third-parties alike by providing the third-parties access to such transaction information (e.g., for analysis and marketing purposes).

In some implementations, the compiled information can be used to provide value added services to the users themselves. For example, as shown in FIG. 5C, the server 110 can be accessible by or share the recorded transaction information with a third-party value added services provider (VAS) computing system 550. As would be understood by those in the art, traditional VAS provider systems are generally associated with a particular payment card, or a specific merchant, or issuer. However, integration of the VAS system with the server 110 provides a user with greater opportunity to receive benefits from the VAS due to the broader scope of user transactions performed in relation to the system (i.e., transactions recorded irrespective of the particular transaction account). The server 110 can also be configured to provide VAS offerings received from the VAS system 550 directly to the user through the user portal or by pushing notifications directly to the user's contact addresses. In addition, the dashboard provided by the server 110 to the user also provides a single user-interface through which a user can manage records, review transactions and receive VAS rewards/offerings relating to transactions performed using multiple different transaction accounts.

The independent configuration of the server 110 in relation to a variety of different acquirers, issuers and payment device networks also provides additional value to the VAS providers. In particular, physical integration is simplified (e.g., only a single integration with the server 110 is required to associate the VAS system with transactions conducted using many different payment processing systems). In addition, analytics provided by the server 110 to the VAS is also richer and more comprehensive than available from current transaction processing systems by virtue of the wider variety of data collected, recorded and monitored by the server 110. Similarly, analytics and other transaction information can be provided by the server 110 to other entities that are part of the payment processing system 105. For example, as shown in FIG. 5B, the server 110 can be configured to transmit analytics and transaction information to the issuing entity computing device 108 thereby providing the issuer detailed information and analytics about transactions (e.g., who was involved in transaction, how was it processed, where did it take place, when it took place and the like).

At this juncture, it should be noted that although much of the foregoing description has been directed to systems and methods for facilitating the transmission of electronic records concerning transactions and maintaining records of transactions using a server 110, the systems and methods disclosed herein can be similarly deployed and/or implemented in scenarios, situations, and settings far beyond the referenced scenarios. It can be readily appreciated that system 100 can be effectively employed in practically any scenario where a transaction is conducted between one or more parties, whether in person or via electronic methods, and it is desirable to transmit an electronic record memorializing the transaction to one or more of the parties and to maintain comprehensive records of a user's transactions irrespective of the particular transaction account that was used to conduct the transactions. It can be also appreciated that the arrangement of computing devices and transaction processing steps can vary according to the particular type of transaction (e.g., bank transaction, credit card, debit card, pre-paid card, NFC payment, a reservation, subscription or other arrangement established between two parties and the like), as would be understood by those skilled in the art.

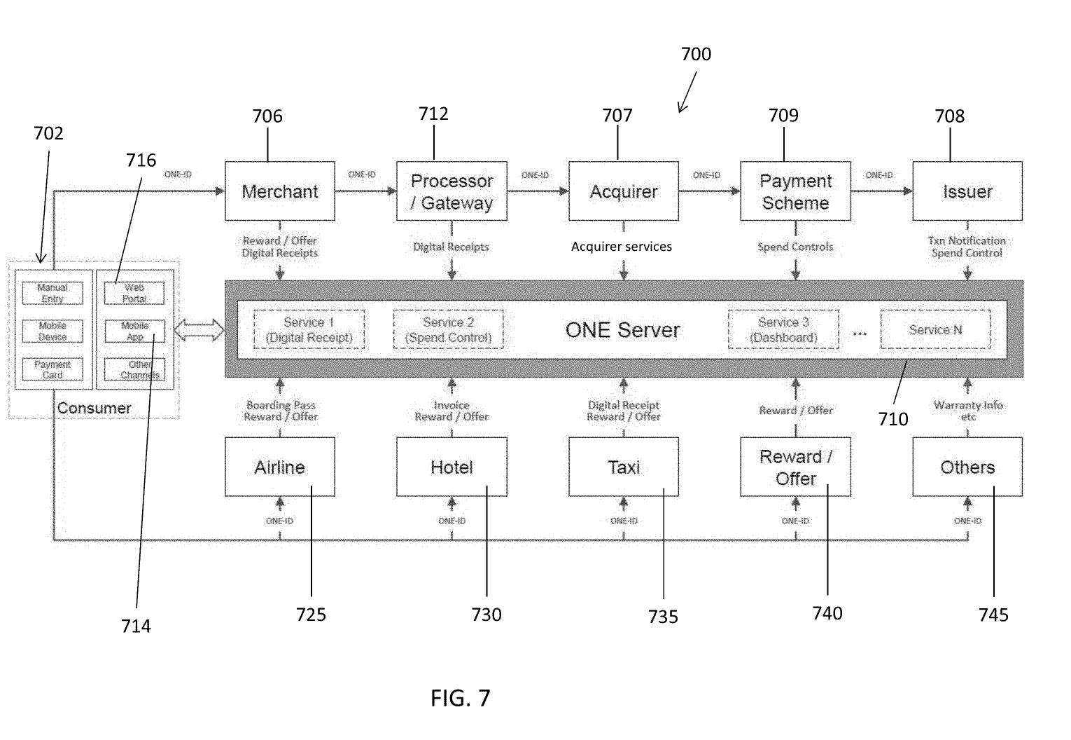

For instance, FIG. 7 is high-level diagram depicting another exemplary configuration of a system for facilitating the automatic provisioning of an electronic record to a user who is conducting a transaction using a transaction terminal and also illustrates the interconnectivity between the various devices of the system. As shown in FIG. 7, the system 700 includes a user device 702, which in this exemplary configuration is the user's personal computing device, such as a smartphone, and is also the terminal that is being used to conduct the transaction. Accordingly, it can be appreciated that the user device 702 can be used to conduct transactions with a variety of different third party service providers as well as to communicate with a back-end server 710 that is configured to automatically provision records of the user's transactions. As noted above, provisioning can include maintaining records of the transactions and automatically transmitting the records to the user using a contact address or otherwise providing the user with access to the records. Such access can be provided through a web-based portal 716 (e.g., using an internet browser), a report provisioning client application 714 and other such channels for connecting the mobile device to the server 710.

In some implementations, the user device 702 can be used to conduct a payment transaction with a merchant that is processed in a similar manner to the exemplary embodiments described in relation to FIGS. 1-6C. As shown in FIG. 7, the user device 702 being used to conduct a transaction can be in communication with one or more computing devices configured to process payment transactions. For instance, the computing devices for processing transactions can include a merchant e-commerce system 706, payment processor/gateway 712, an acquiring entity computing device 707, a payment device network or scheme 709, and an issuing entity computing device 708. FIG. 7 depicts these remote systems as being in communication with the user device 702 over a network, however, it should also be appreciated that one or more of the devices can be in closer physical proximity and communicating with the user device over a close-range wireless communications medium. For instance, merchant system 706 can represent a point-of-sale terminal for processing transactions conducted in person in conjunction with other remote transaction processing systems (e.g., devices 712, 707, 709 and 708).

As shown in FIG. 7, the user device 702 can also be in communication over a network with one or more computing systems that process various types of electronic transactions between the user and respective third party service providers. These additional third-party service provider transaction processing systems can include, for example and without limitation, an airline ticketing system 725, a hotel reservation system 730, a taxi/livery service system 735, a membership rewards/offer system 740, and other such computing systems (e.g., computing system 745). It should be appreciated that, as shown in FIG. 7, each of the remote computing devices that are described as processing transactions or providing services in connection with computer-based transactions can also be configured to interact with the server 710 over a communications medium, for example, using an application programming interface (API). As such, these systems can be configured to provide information concerning transactions conducted with the user directly to the server 710 for record provisioning.

In some implementations, the user device 702 can be configured to conduct transactions with any of the remote computing devices over a communications network such as the internet, for instance, through a web-based portal or a stand-alone application for accessing a particular transaction processing system say, the airline ticketing system 725.

In some implementations, the user device 702 can be executing a client application that enables the user device to access and interact with the server 710 for automated receipt provisioning. In addition, the client application can also configure the user device to provide the user's global ID to a remote transaction processing system in connection with a transaction and thereby facilitate automatic provisioning of records associated with the transaction. For instance, the client application can integrate with a stand-alone mobile application for making reservations with the airline ticketing system 725 executing on the user device. Furthermore, the client application can provide the user's global ID to the airline ticketing system via the stand-alone mobile application. As shown in FIG. 7, the airline ticketing system 725 is preferably integrated with the server 710 via an API and is configured to provide data and information concerning the transaction to the server 710 (e.g., transaction details, a receipt for a reservation, an electronic ticket, associated rewards and offers and the like) for further processing and record provisioning. Accordingly, as described above and further described herein, the server 710 can automatically provide the user with transaction records through direct messaging to an electronic contact address or through a web-based portal or the client application.

Although in this particular example, the transaction is described as being performed directly between the user device 702 and the remote computing system (e.g., airline ticketing system 725), it can be appreciated that the concepts for automated receipt provisioning can be implemented in connection with a transaction conducted by a user using a dedicated terminal, say, an airline ticketing kiosk (not shown) and using a personal transaction device (not shown) and/or a user computing device (e.g., user device 702). For instance, the user can swipe a payment card at the kiosk to make a reservation or access an existing reservation via the kiosk. In addition, the user can also provide the user's global ID to enable automatic record provisioning. As noted previously, the global ID can be captured at the kiosk through a number of different methods including: automatically reading the global ID from the storage medium of a personal transaction device; manual input by the user at the kiosk; oral communication by the user at the kiosk; automatically capturing the global ID from a user's personal computing device (e.g., user device 702) through contactless communication methods.

In some implementations, the global ID can be received by the transaction processing system (e.g., airline ticketing system 725) over a separate communication channel and independent of the processing of a corresponding transaction. For instance, the user device 702 can be configured to transmit the global ID directly to the airline ticketing system 725 over a network connection and independent of the transaction being conducted using, say, the kiosk or a dedicated ticketing application/portal. This can obviate the need for providing the global ID to a kiosk or an application that is conducting the transaction for further transmission to the back-end ticketing system 725. In such a configuration, the transmission of the global ID can include a reference to the corresponding transaction that can be captured by the user device 702. For instance, the kiosk or application being used to conduct the transaction can be configured to output a unique identifier for the transaction that can be captured by the user device 702 executing the client application and then provided to the airline ticketing system 725 along with the global ID. Accordingly, the airline ticketing system 725 can associate the global ID with the particular transaction based on the transaction identifier and automatically provide information concerning the transaction to the server 710 for automated record provisioning.

It is to be understood that like numerals in the drawings represent like elements through the several figures, and that not all components and/or steps described and illustrated with reference to the figures are required for all embodiments or arrangements. Thus, illustrative embodiments and arrangements of the present systems and methods provide a computer implemented method, computer system, and computer program product for facilitating the automatic provisioning of an electronic record to a user conducting a transaction at a transaction terminal. The flowchart and block diagrams in the figures illustrate the architecture, functionality, and operation of possible implementations of systems, methods and computer program products according to various embodiments and arrangements. In this regard, each block in the flowchart or block diagrams can represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the present invention, which is set forth in the following claims.

What is claimed is:

1. A method for facilitating an automatic provisioning of an electronic record to a user completing a transaction at a transaction terminal using a transaction account associated with a first payment network among a plurality of payment networks, comprising:
providing, by a server to a transaction processor, a record provisioning application, wherein the transaction processor is coupled to the transaction terminal and processes the transaction using the transaction account associated with the first payment network;
receiving a record provisioning request at the server over a communication network from the transaction processor in connection with processing of the transaction, the record provisioning request including transaction information, transaction account information and non-transaction account information including a global ID;
identifying, by the server based on the global ID, a user profile associated with the global ID among a plurality of user profiles stored in a non-transitory storage medium, the user profile including one or more electronic contact addresses and one or more contact preferences;
confirming, by the server to the transaction processor based on the identification of the user profile, that the record provisioning request is processable; generating, by the server based on the one or more contact preferences and the transaction information and the transaction account information, an electronic record concerning the transaction using the transaction account associated with the first payment network for transmission to at least one electronic contact address associated with the global ID; and
transmitting the electronic record by the server over the communication network to the electronic contact address,
wherein the generating and transmitting steps are performed free of contact with the transaction terminal and irrespective of the particular payment network associated with the transaction account.

2. The method of claim 1, further comprising:
recording, by the server, information concerning the transaction in the user profile.

3. The method of claim 1, wherein the record provisioning request includes only a portion of: the transaction information, the transaction account information and the non-transaction account information including the global ID.

4. The method of claim 1, further comprising:
enrolling the user, wherein enrolling the user includes:
receiving, by the server over a network from a user device operated by the user, user identification information identifying the user;
receiving, by the server from the user device, information concerning a plurality of transaction accounts associated with the user and a respective payment network among the plurality of payment networks;
receiving, by the server from the user device, the one or more contact addresses;
receiving, by the server from the user device, the one or more contact preferences;
providing, by the server to the user via the user device, the global ID, wherein the global ID is unique to the user;
storing, by the server in the user profile, the global ID, the user identification information, the transaction account information, the one or more contact addresses and the one or more contact preferences in the user profile, wherein the user profile maps the plurality of transaction accounts associated with the user to a single global ID irrespective of the respective transaction account issuing entity.

5. The method of claim 4, wherein the step of providing the global ID comprises one or more of:
receiving the global ID by the server from the user device; and
generating the global ID by the server, and providing the global ID to the user via the user device.

6. The method of claim 1, wherein the contact preferences specify one or more of:
one or more electronic contact addresses to automatically transmit the electronic record to;
priority levels for the one or more electronic contact addresses such that the electronic record is transmitted to the one or more contact addresses according to the priority levels;
instructions to not automatically transmit the record to any of the one or more electronic contact addresses.

7. The method of claim 1, wherein the one or more electronic contact address include an email address, social network identifier, a networked electronic storage device address, or a telephone number associated with the user.

8. A method for facilitating an automatic provisioning of an electronic record to a user completing a transaction at a transaction terminal using a transaction account associated with a first payment network among a plurality of payment networks, comprising:
receiving, at a transaction processor from a server, a record provisioning application, wherein the transaction processor is coupled to the transaction terminal;
receiving, at the transaction processor from the transaction terminal, transaction information, transaction account information and non-transaction account information including a global ID;
processing the transaction using the transaction information, and transaction account information by the transaction processor;
executing, in a processor of the transaction processing device, the record provisioning application, wherein the record provisioning application configures the transaction processor to perform the steps of:
transmitting, by the transaction processor to the server over a communication network and irrespective of the particular payment network associated with the transaction account, a record provisioning request including the transaction information, the transaction account information and the non-transaction account information including the global ID, wherein the transmitting of the record provisioning request is performed irrespective of the particular payment network associated with the transaction account;
awaiting, by the transaction processor, record of a confirmation from the server that the record provisioning request is processable by the server;
concluding the processing of the transaction by the transaction processor based on record of the confirmation from the server; and
transmitting, by the transaction processor to the server, a notification of the conclusion of the processing of the transaction.

9. The method of claim 9, wherein the record provisioning application further configures the transaction processor to perform the steps of:
determining that the non-transaction account information includes the global ID, and
generating the record provisioning request based on the determining step.

10. The method of claim 1, wherein the step of processing the transaction by the transaction processor further comprises:
transmitting, based on the transaction information and the transaction account information, the transaction information and the transaction account information to at least a remote transaction processing system associated with the first payment network for processing;
receiving, by the transaction processor from the remote transaction processing system, an authorization notification; and
transmitting, by the transaction processor to the server, the authorization notification.

11. The method of claim 10, wherein the record provisioning request includes the authorization notification.

12. The method of claim 9, further comprising:
receiving a message while awaiting the confirmation, and
based on the message transmitting an instruction to the transaction terminal causing the transaction terminal to prompt the user to reenter the global ID at the transaction terminal.

13. The method of claim 10, wherein the step of concluding the processing of the transaction by the transaction processor is based on record of the confirmation from the server and the authorization notification.

14. The method of claim 9, wherein the transaction terminal is a point of sale device.

15. The method of claim 9, transmitting, by the transaction processor to the transaction terminal, a notification including the authorization notification and the confirmation from the server.
